(19) United States
(12) Patent Application Publication
(10) Pub. No.: US 2013/0227416 A1
(43) Pub. Date: Aug. 29, 2013

(54) DEVICE FOR LOGGING, EDITING AND PRODUCTION OF VIDEO PROGRAMS FOR ACTIVITIES OF LOCAL INTEREST

(71) Applicants: Edward Massena, Elmsford, NY (US); Jonathan Krackehl, Wilton, CT (US); Marc Lapierre, Brossard (CA); Harlan Neugeboren, Stamford, CT (US)

(72) Inventors: Edward Massena, Elmsford, NY (US); Jonathan Krackehl, Wilton, CT (US); Marc Lapierre, Brossard (CA); Harlan Neugeboren, Stamford, CT (US)

(21) Appl. No.: 13/615,579

(22) Filed: Sep. 13, 2012

Related U.S. Application Data
(63) Continuation-in-part of application No. 13/592,817, filed on Aug. 23, 2012.
Application No. 13/592,817 is a continuation of application No. 13/345,406, filed on Jan. 6, 2012, now abandoned.
Application No. 13/345,406 is a continuation-in-part of application No. 13/345,406, filed on Jan. 6, 2012, now abandoned.
(60) Provisional application No. 61/430,503, filed on Jan. 6, 2011.
(60) Provisional application No. 61/430,503, filed on Jan. 6, 2011.

(51) Int. Cl. G06F 3/0488

(52) U.S. Cl. CPC G06F 3/0488
USPC 715/723

(57) ABSTRACT

To prepare video productions more cost effectively for a local audience, a computerized tool and workflow is provided that integrates the operations of logging an event, editing video of the event and outputting the edited video of the event in the same device, such as a tablet computer. This tool and workflow allow metadata about an activity, such as local sports games, to be efficiently and consistently entered and associated with video. This metadata also is designed to assist in the editing of video about an activity. As a result, the logging of data about an activity is used as a video production tool and reduces the cost of video production. Further, its integration in the same device with a video editing system and tools for distributing edited video further reduces the costs of producing, editing and distributing video programs of local interest.

### CROSS REFERENCE TO RELATED APPLICATIONS

This application is a continuing application of, and claims priority to and the benefits under 35 U.S.C. §120 of, U.S. patent application Ser. No. 13/592,817, filed Aug. 23, 2012, entitled “LOGGING, EDITING AND PRODUCTION SYSTEM FOR ACTIVITIES OF LOCAL INTEREST AND RELATED VIDEO,” now pending, hereby incorporated by reference, which is a continuing application of U.S. patent application Ser. No. 13/345,406, filed Jan. 6, 2012, entitled “LOGGING, EDITING AND PRODUCTION SYSTEM FOR ACTIVITIES OF LOCAL INTEREST AND RELATED VIDEO,” now abandoned, hereby incorporated by reference, which is a nonprovisional application of U.S. Provisional Patent Application 61/430,503, filed Jan. 6, 2011, entitled “LOGGING, EDITING AND PRODUCTION SYSTEM FOR SPORTS EVENTS AND RELATED VIDEO.

This application is a continuing application of, and claims priority to and the benefits under 35 U.S.C. §120 of, U.S. patent application Ser. No. 13/345,406, filed Jan. 6, 2012, entitled “LOGGING, EDITING AND PRODUCTION SYSTEM FOR ACTIVITIES OF LOCAL INTEREST AND RELATED VIDEO,” now abandoned, hereby incorporated by reference, which is a nonprovisional application of U.S. Provisional Patent Application 61/430,503, filed Jan. 6, 2011, entitled “LOGGING, EDITING AND PRODUCTION SYSTEM FOR SPORTS EVENTS AND RELATED VIDEO.”

This application is a nonprovisional application of, and claims priority to and the benefits under 35 U.S.C. §119 of, U.S. Provisional Patent Application 61/430,503, filed Jan. 6, 2011, entitled “LOGGING, EDITING AND PRODUCTION SYSTEM FOR SPORTS EVENTS AND RELATED VIDEO,” now expired, which is hereby incorporated by reference.

### BACKGROUND

Traditional video production techniques are expensive to use when preparing video for a small, local audience. For example, local school sports and other activities have a sufficiently small audience that the cost of traditional video production, to regularly prepare good quality video productions, is prohibitive.

### SUMMARY

To prepare video productions more cost effectively for a local audience, a computerized tool and workflow is provided that integrates the operations of logging an event, editing video of the event and outputting the edited video of the event in the same device, such as a tablet computer. This tool and workflow allow metadata about an activity, such as local sports games, to be efficiently and consistently entered and associated with video. This metadata also is designed to assist in the editing of video about an activity. As a result, the logging of data about an activity is used as a video production tool and reduces the cost of video production. Further, its integration in the same device with a video editing system and tools for distributing edited video further reduces the costs of producing, editing and distributing video programs of local interest.

A logging tool is configured to capture data according to a kind of activity, such as a basketball game, football game or other activity of local interest. The logging tool can be preconfigured with information about a specific activity, such as the date, time, venue, and participants, such as teams and players. The logging tool provides a simple interface on the device for a user to enter data about events occurring during the activity. Video production with this tool involves having a journalist use the tool during the activity to log data (e.g., in basketball, shots taken, player names, etc.).

Data about events occurring during an activity is entered during the activity and is time stamped. This data is associated and synchronized with video for the activity. The time stamped data can be used to generate clips of the video from the activity, based on synchronization between the logged data and the video, and the time stamps of the logged data. The data also can be used to generate graphics that can be overlaid on the video clips with which it is associated.

After the activity, the logged data can be synchronized with the video in a video editing system on the device by using the time for each event to identify the corresponding video for the events. The logged data can be used by the video editing system to create clips from the video (e.g., key plays in a basketball game can be identified in the logged data, and the time information for those plays are used to retrieve clips of video for those plays). The resulting clips, and their associated metadata, can be sequenced (typically in the order they occur during the activity) and combined into a video program. The video program can be uploaded from the device to a video server or other channel for distribution. When the video program is played back, the metadata from the clips can be used to create on-screen graphics.

### DESCRIPTION OF THE DRAWINGS

FIG. 1 is a data flow diagram illustrating a device for production, logging and editing video of an activity of local interest.

FIG. 2 is a state diagram for an example implementation of a logging tool.

FIG. 3 is a flowchart of an example implementation of the editing tool.

FIG. 4 is a block diagram of an example system using such a device for logging and editing sports activities and related video.

FIG. 5 is an illustration of an example user interface for a logging tool.

FIG. 6 is an illustration of an example user interface for an editing tool.

FIG. 7 is an illustration of an example user interface for an editing tool.

FIG. 8 is an illustration of an example user interface for an editing tool.

FIG. 9 is an illustration of an example user interface for a logging tool.

FIG. 10 is an illustration of an example user interface for a logging tool.

FIG. 11 is an illustration of an example user interface for a logging tool.

FIG. 12 is an illustration of an example user interface for a logging tool.

FIG. 13 is an illustration of an example user interface for a logging tool.

### DETAILED DESCRIPTION

Logging of data from a sports activity or other activity of local interest is simplified by providing a logging tool in a device, such as a tablet computer, with a simple interface that allows events during the activity to be tracked with time stamps. This information about events occurring during the activity can be associated and synchronized with video for the events to allow video programs to be quickly edited by a video editing system in the device. The logging tool can be preconfigured with information about the activity, including the date, time, venue, and participants, such as teams and players.

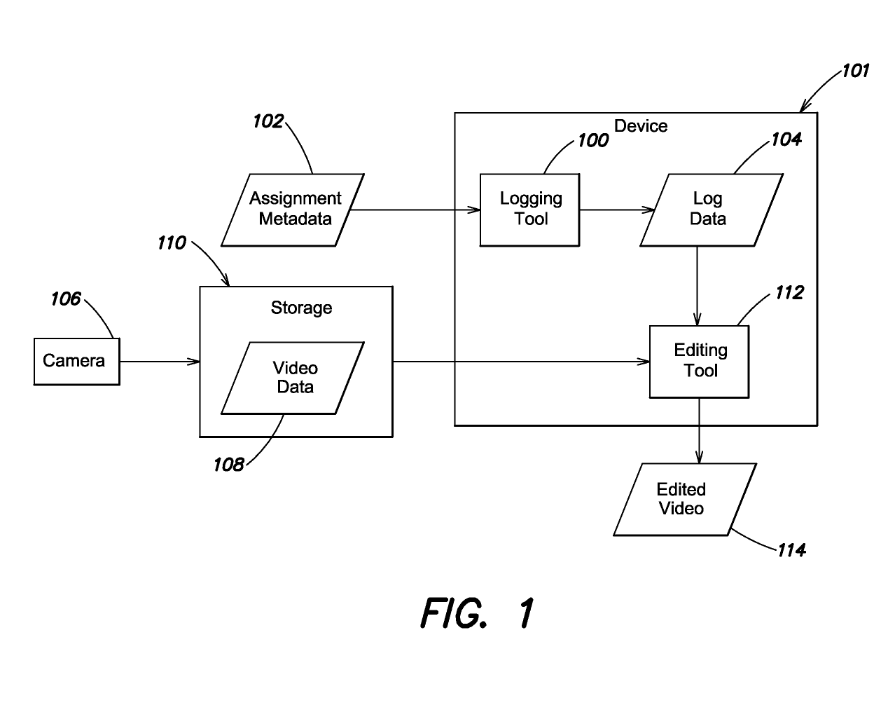

Referring to FIG. 1, a logging tool 100 in a device 101 receives assignment metadata 102 that describes the activity for which video will be captured and events will be logged. Such metadata can include, but is not limited to, the type of activity, participants, date, time, venue, etc. An example of an assignment file containing assignment metadata is shown in Appendix A.

The logging tool generally allows a user to enter data about different kinds of events that occur during the activity, as those events occur. In particular, as shown in the example implementations below, an activity of a certain type typically has several types of events that can occur during the activity. For example, in a basketball game, there can be a foul shot, a 2-point shot, a 3-point shot, etc. In baseball, there can be a strike, a ball, a walk, an “at-bat”, a double play, a home run, etc. An event also can have one or more participants associated with it, such as the player. A user interface for the logging tool can present each of these kinds of events for selection, such as through a button on a touch screen. The logging tool also has a clock that is running during the event. When the user selects a kind of event, a time stamp for that selection is generated from the clock. The logging tool then can present a user interface to the user through which various information about the event can be input. The logged events are output as log data 104, which includes a list of event records, with each event indicating at least a type of event and a time, such as a time stamp or a time range (e.g., start and stop times), for the event. Examples of log files are shown in Appendix B and Appendix C. The log data 104 can be stored in data files on the device 101. The device 101 can be, for example, a tablet computer with a touch screen user interface, such as an iPad computer from Apple Computer of Cupertino, Calif.

One or more video cameras 106 also are used during the activity to create a video recording of the activity. For example, an AVCHD compliant video camera that records video in *.mts files on SDHC cards in 720/60 p drop frame format can be used. Each video camera also has a clock or other mechanism from which time stamps for the video recording can be derived. The clock from the user interface of the logging tool also can be recorded in the video recording of the activity to assist in later synchronization. The video recording is stored as data files 108 in computer-readable storage 110. For example, the video camera can store video data in files on an SD card (not shown) which can then be entered into the device 101 for access by applications on the device 101.

An editing tool 112 in the device 101 receives log data 104 and information about the video recording from the data files 108, and allows an editor to produce an edited video 114 of the activity. In particular, the editing tool imports a file containing the log data 104 and the video files from the SD card into storage on the device 101, wrapping the video files from the camera (typically in *.mts format) into a different format (typically a *.mov file format) for ease in editing.

The editing tool receives input from a user to select events from the log data, and in turn select clips of the video recording from the data files 108 based on the time stamps for the selected events. The editing tool then outputs an ordered list of these clips as the edited video 114. For example, each time stamp of an event is used to define a range of video (e.g., an amount of time before the event plus an amount of time after the event). As a particular example, each button in the logging tool that can be pressed creates a specific time code-referenced clip based on the running clock, with an in point at −10 seconds, and an output at +5 seconds from the current time stamp. For example if the user presses an event button at 15:42:35, the log file will include an event defining a clip with an in-time of 15:42:25 and out-time of 15:42:40, and thus 15 seconds run time. The values for the in point offset and out point offset can be adjustable per activity and per event type. The time stamps for events in the log data can be synchronized with the time stamps of the video in the editing tool by identifying and storing an offset between the logging tool clock and the video camera clocks.

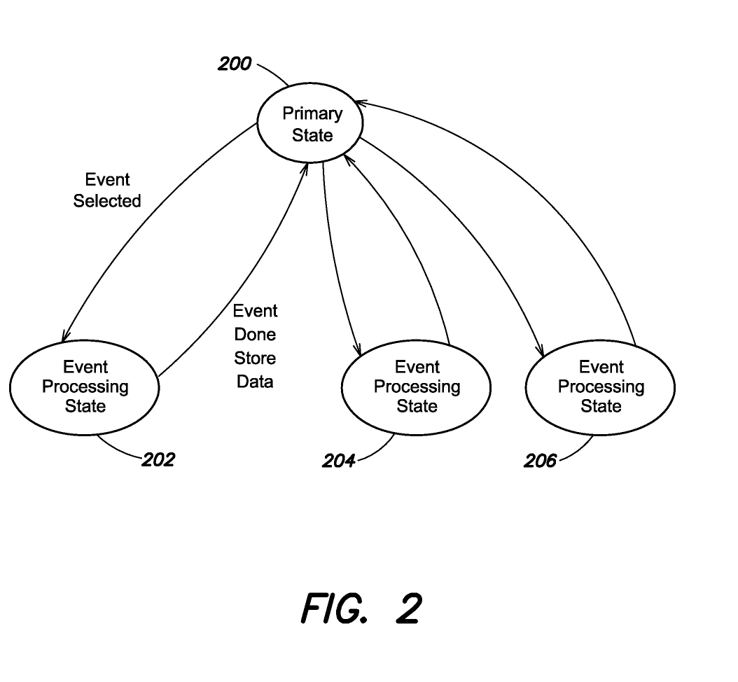

Referring now to FIG. 2, a state diagram for an example implementation of a logging tool will now be described. In general, the logging tool as a primary state 200 in which a user interface for inputting events is displayed. Upon selection of an event, a transition to an event processing state, e.g., 202, occurs. The number of event processing states, e.g., 204, 206, etc., is dependent on the number of kinds of events that the logging tool is designed to track. In the event processing state, a user interface is displayed that allows a user to enter data for the event. When a user completes the input, the logging tool stores the event data, and transitions back to its primary state 200.

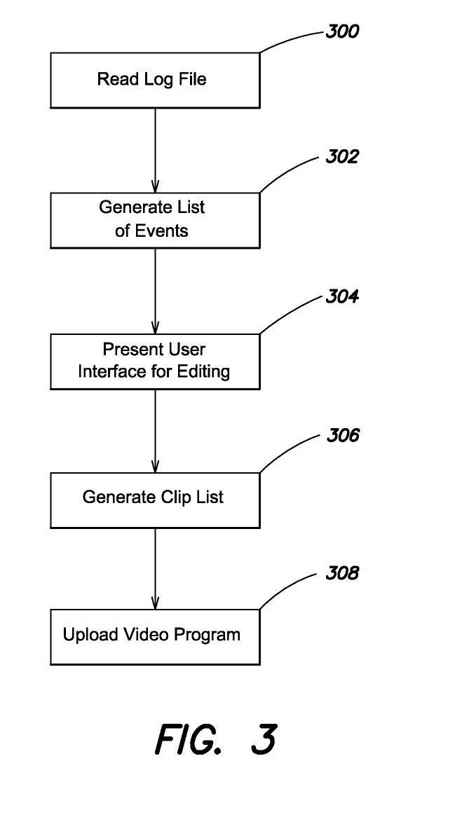

Referring now to FIG. 3, a flowchart of an example implementation of the editing tool will now be described in more detail. The editing tool reads 300 a log file and processes the log file to identify each event. A list of events is generated 302 and displayed to the user. A user interface is presented 304 through which an editor can select one or more events for placement in the edited program, preview clips of events, trim clips of events, and perform other editing functions. Through such editing functions, a clip list is generated 306. The editing tool then allows the clip list to be uploaded 308 to a system from which the edited video program can be generated, played back or otherwise distributed.

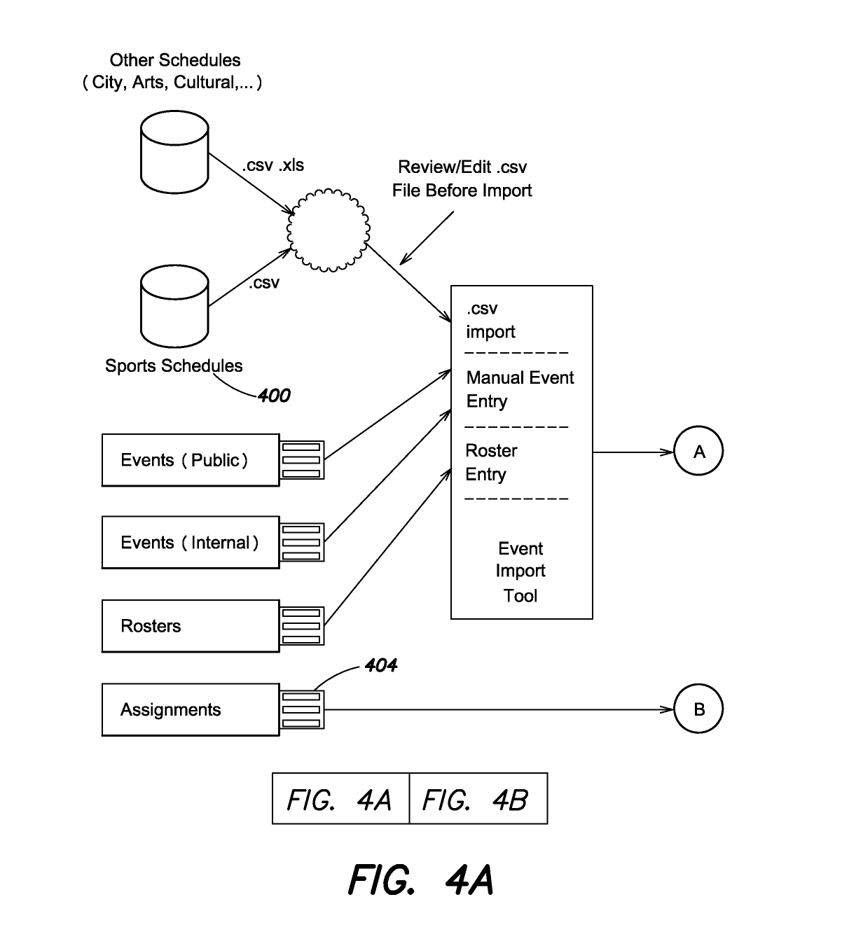

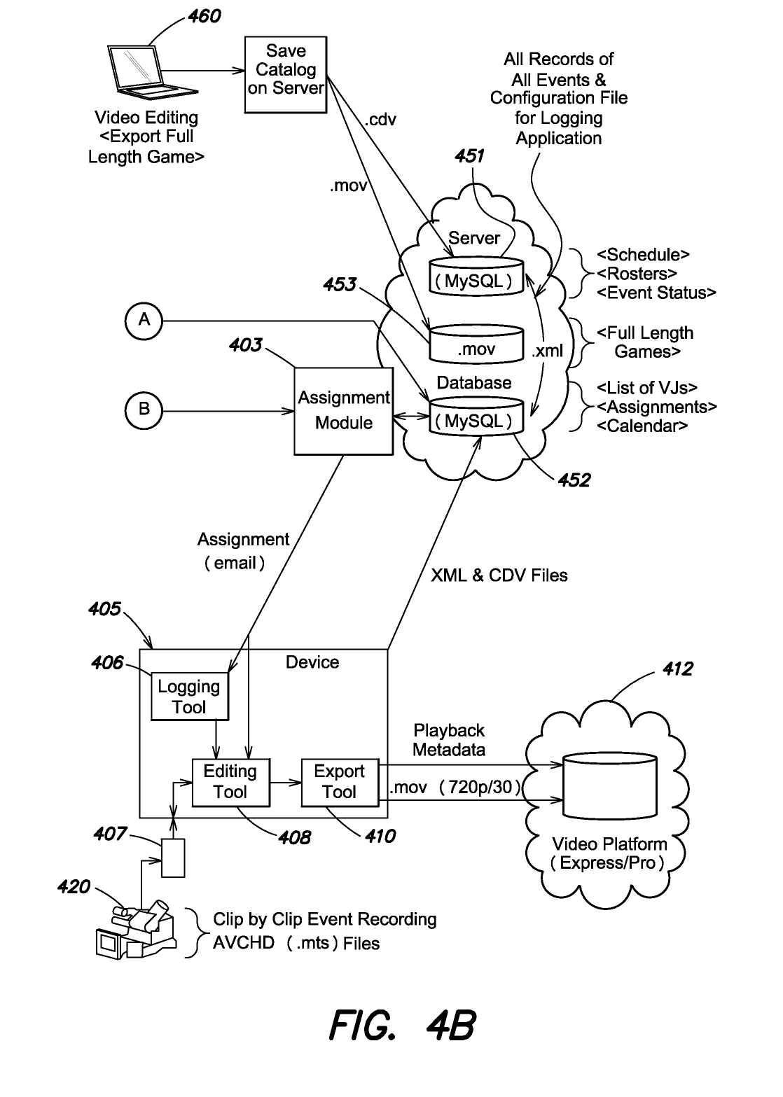

An example implementation of a system using such a device will now be described in connection with FIG. 4. Early in the sport season, or ideally prior to the start of the sport season, sports schedules and team rosters are typically available (see 400 in FIG. 4). An assignment file 404 is created by an assignment module 403 using the schedule, team roster and production team member (coordinator, journalist) information. The production team includes those individuals who will be responsible for logging the events at a game or activity. The assignment is made available and/or transferred to a logging application 406. Referring to FIG. 4, this information (400, 404) can be stored in a database such as shown at 402. The database 402 may include a database 452 for production (such as production team members and their assignments and calendars), an event database 454 (storing information such as schedules, rosters and event status) and a video database 453.

At a game, the journalist opens the assignment file using the logging application 406 on the device 405 and gets ready to log the events during the game. For example, the journalist may set the color in the user interface for each team, identify the players present at the game, select the players that are on the field, add new players, etc.

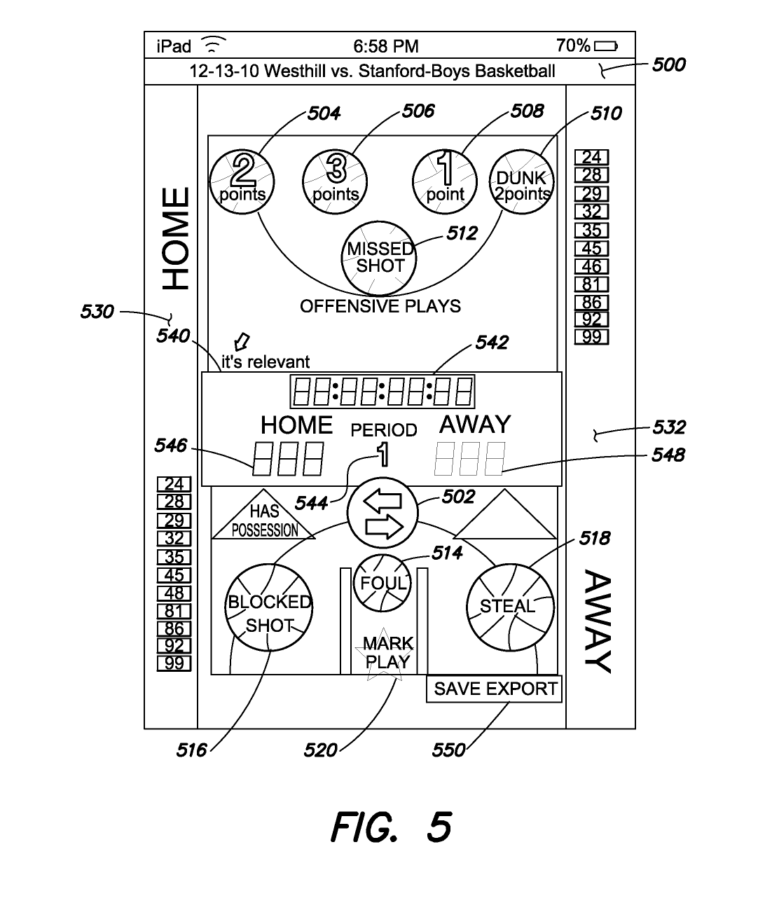

During a game, the journalist logs events in real time as they happen by pressing buttons in a user interface of a logging application 406. Example user interfaces are described below in connection with FIGS. 5 and 9-13. This application ideally has a touch screen-based graphical user interface, such as provided by a mobile device or tablet computer. The journalist can review the logged events, make changes, undo entries, etc.

Events created by the logging application during this process use a combination of values provided in the assignment file, generic metadata fields/keys and sports-specific metadata fields/keys provided by a configuration file or an equivalent set of metadata fields/keys pre-programmed in the logging application. An example naming convention for basketball for each logged event is described below. Other sports follow a similar pattern. During the game, one or more video cameras 420 also record video of the game which is stored on a removable storage device 407. A clock on the device with the logging tool also can be displayed in an hours:minutes:seconds (HH:MM:SS) format. This clock can be captured on video on the video camera at some point before, during or after the game to allow synchronization between the clock on the device and the video files on the camera (which has its own clock).

After the game is finished, or after each period/quarter/half, the journalist saves the log file locally to the device and/or can upload the log files to a server for long term storage. The log file(s) then are used by an editing application 408 on the device. The journalist imports video data into the editing application, opens the logging application file(s) in the editing application, assigns media to the sub clips, trims the sub clips, filters the sub clips to select the ones that are relevant and then can output the video program in any of a variety of formats.

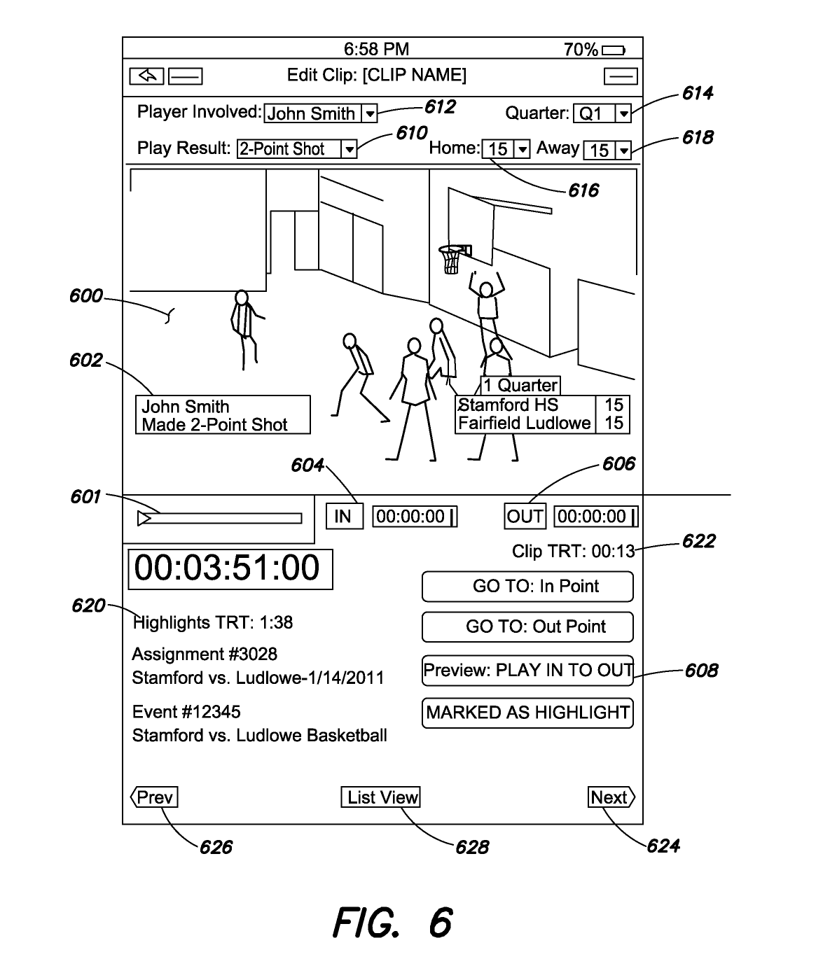

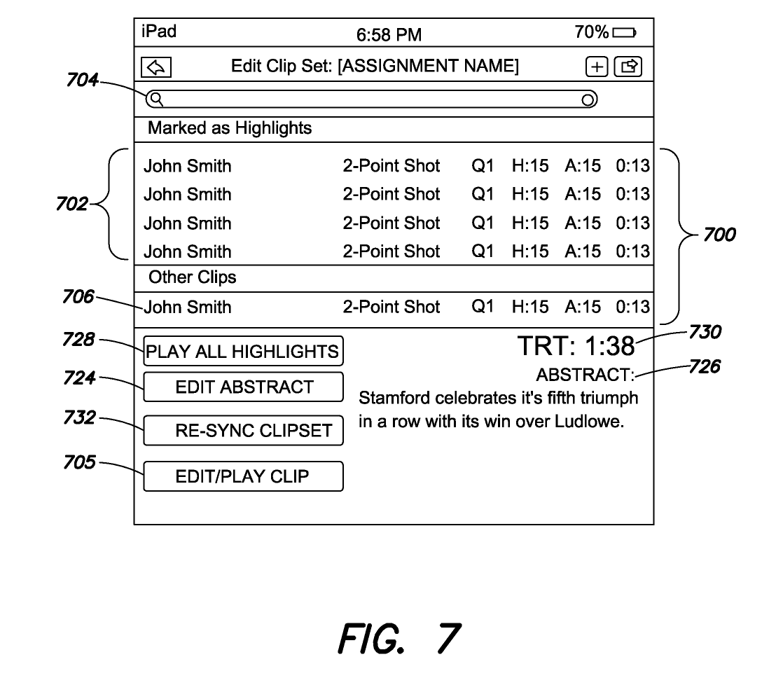

The editing application pairs up video files imported from the removable storage of the video camera with log files made using the logging application. This pairing can be accomplished by having a same unique identifier associated with the assignment file and the video files used for an event. An editor, using the editing application, can review selections made in the logs by watching the video, changing in points and out points, editing details in the metadata of each clip, and deleting clips when necessary. An example user interface for the editing tool is described below in connection with FIGS. 6-7. The editing application then outputs the video program in any of a variety of formats for distribution using the export tool 410.

An example workflow for an editor using the logging and editing applications is the following. First, the user logs a game using the logging application. Time code is generated from time of day on the device. The logging application stores this log on the device as an XML file. The user inserts the removable storage from the camera into the device. The editing application opens the XML file and imports video data from the camera's storage, now in the device. The editing application prompts user to align an event in the log file with the imported video with a standard time offset. A button such as a “Tip off marker” would be a simple way to provide a synchronization of the video with the logged event data. The user could be prompted to “Touch Here” when a designated event in the log file occurs in the video, such as a tip off in a basketball game. The user uses the editing application to review clips. They are able to sort (organize) and filter (display only certain ones) the clips by time, player name, player number, play type, highlight flag, length of clip, or club (team name). The user then can set new in points and out points for each logged play with an easy to use playback interface. The user can select clips to include in the “highlights,” such as by pressing a toggle button (green and red) or other object associated with the clip in the interface. The selected highlights can be used to define an initial clip set. The user then instructs the editing application to export the video program. The editing application generates a final video program file, which then can be uploaded to any distribution channel.

The editing application or other tool also can upload the log files, files created by the editing system and video files to a database, such as database 402, so that other editing applications 460 or other video processing and distribution applications can access this information for a variety of purposes.

Referring now to FIG. 5, an example user interface for a logging tool will now be described. This user interface has been designed for logging a basketball game.

Prior to displaying this interface, the logging tool can display a color selector to allow the journalist to select a color for each of the teams. The selected colors are used in the logging interface as background color for buttons assigned to the teams.

The user interface of FIG. 5 is a main page from which logging is performed. For most actions, the user presses only two buttons without requiring confirmation. Escaping from an event button generally is accessible by pressing anywhere outside a dialog screen according to usual user interface convention.

Within the user interface, a title bar 500 displays the name of the selected assignment file. The title bar also can display navigation buttons in order to provide the user with access to the ability to select a different assignment file, change color selections, or view, save or export the log file and participant information.

A center button 502 makes the possession status toggle between the HOME team (on the left) and the AWAY team (on the right). Each time this button is pressed, a “BK_Possession” variable is set to the selected team (BK_Possession=HomeTeam or AwayTeam).

The main logging buttons will now be described in connection with Table I, which describes the actions tied to each button available. The table indicates the metadata keys values (BK_PlayResult, and HighlightFlag) associated with the press of each button. The Notes indicate other actions that are performed by the logging tool, such as updating the score, or prompting the journalist for information about the player. Each time one of the buttons is pressed, the user is prompted to identify the player(s) that was (were) involved in the logged event. A user interface with buttons corresponding to each of the players can be displayed for this purpose. With such an interface, the user can either select a player from the HOME or AWAY team, or, in the event he does not know which player was involved, he can select the HOME or AWAY team button.

TABLE I

| Button | BK_PlayResult | HighlightFlag | NOTES |
|---|---|---|---|
| 2 Points -- 504 | 2 Point Shot | FALSE | If the user selects a player on the HOME |
| | | | team then |
| | | | HomeTeamScore = HomeTeamScore + 2. If |
| | | | the user selects a player on the AWAY |
| | | | team then |
| | | | AwayTeamScore = AwayTeamScore + 2. |
| 3 Points -- 506 | 3 Point Shot | TRUE | If the user selects a player on the HOME |
| | | | team then |
| | | | HomeTeamScore = HomeTeamScore + 3. If |
| | | | the user selects a player on the AWAY |
| | | | team then |
| | | | AwayTeamScore = AwayTeamScore + 3. |
| 1 Point -- 508 | 1 Point Shot | FALSE | If the user selects a player on the HOME |
| | | | team then |
| | | | HomeTeamScore = HomeTeamScore + 1. If |
| | | | the user selects a player on the AWAY |
| | | | team then |
| | | | AwayTeamScore = AwayTeamScore + 1. |
| Dunk 2 Points -- 510 | 2 Point Dunk | TRUE | If the user selects a player on the HOME |
| | | | team then |
| | | | HomeTeamScore = HomeTeamScore + 2. If |
| | | | the user selects a player on the AWAY |
| | | | team then |
| | | | AwayTeamScore = AwayTeamScore + 2. |
| Missed Shot -- 512 | Missed Shot | FALSE | |
| Blocked Shot -- 516 | Blocked Shot | FALSE | |
| Foul -- 514 | Foul | FALSE | |
| Steal -- 518 | Steal | FALSE | |
| Mark Play -- 520 | Mark Play | TRUE | |

Using this example interface, an example of how the state of the system changes and how log events are created will now be described in detail. To start, the current state of the system at the time of a button press is defined. For the example below, the Home team has possession of the ball (BK_Possession=Home), the score is HomeTeam 34 (BK_HomeTeamScore=34), AwayTeam 28 (BK_AwayTeamScore=28), and it is the first quarter of the game (BK_Quarter=1). The assignment file populated a series of fields for which the data never changes during the coverage of an event (such as BK_HomeTeamID, BK_AwayTeamID, EventID, AssignmentID, AssignmentTitle, AssignmentDescription, EventTypeID, CoordinatorInfo, Reporter1Info, Reporter2Info, Club1ID, Club2ID, and the complete list of all the players on both teams, their respective jersey numbers, their position and their identifiers).

In one implementation log events, related to Appendix B, can be created as follows. At T=14:19:40:00, the user presses the <2-points> button. He is then prompted to select the player that scored. He selects #5 from the home team roster (This player's name is Tim Smith, member #245 (MID)). The resulting XML data generated for this logged entry is:

<CLIP INDEX=‘5_Tim Smith_2-Point Shot1’>
<NAME>5_Toby Panawki_2-Point Shot1</NAME>
<IN>14:19:30:00</IN>
<USER62 name=‘BK_PlayersInvolved’>#5 Toby Panawki</USER62>
<USER61 name=‘BK_IDPlayersInvolved’>245</USER61>
<USER43 name=‘BK_HomeTeamID’>West High</USER43>
<USER44 name=‘BK_AwayTeamID’>Sample High</USER44>
<USER1 name=‘EventID’>55</USER1>
<USER63 name=‘BK_Quarter’>1</USER63>
<USER66 name=‘BK_PlayResult’>2-Point Shot</USER66>
<USER8 name=‘AssignmentID’>123</USER8>
<USER12 name=‘AssignmentTitle’>Sample Title</USER12>
<USER13 name=‘AssignmentDescription’>This is a sample assignment
</USER13>
<USER6 name=‘EventTypeID’>4</USER6>
<USER9 name=‘CoordinatorInfo’>Jane Doe</USER9>
<USER10 name=‘Reporter1Info’>Samatha Doe</USER10>
<USER11 name=‘Reporter2Info’>Jason Smith</USER11>
<USER15 name=‘Club1ID’>21</USER15>
<USER16 name=‘Club2ID’>20</USER16>
<USER64 name=‘BK_Possession’>Home</USER64>
<USER20 name=‘Highlight Info’></USER20>
<USER19 name=‘Highlight Flag’>**</USER19>
<USER67 name=‘BK_HomeTeamScore’>36</USER67>
<USER68 name=‘BK_AwayTeamScore’>28</USER68>
<OUT>14:19:45:00</OUT>
<TIMECODE>30</TIMECODE>
</CLIP>

In this example, various data comes from the following fields in the assignment file. The coordinatorInfo field comes from the <coordinator> field. The ReportedInfo field comes from the first <journalist> field. The Reporter2Info field comes from the second <journalist> field. The AssignmentTitle field comes from the <Assignment title> field. The AssignmentDescription comes from the <Assignment description> field. The EventTypeID comes from the <EventType ID> field. The Club1ID comes from the first <Club ID> entry. The Club2ID comes from the second <Club ID> entry.

At T=14:19:40:00, the user presses the <3-points> button. All other parameters except the time code used in the previous example remain the same. The resulting log entry is created, noting only the values of the various metadata keys that are different from the 2-Point example, except the time code. The remaining log entries below are similarly presented.

<USER66 name=‘BK_PlayResult’>3-Point Shot</USER66>
<USER19 name=‘Highlight Flag’>****</USER19>
<USER67 name=‘BK_HomeTeamScore’>37</USER67>

At T=14:19:40:00, the user presses the <1-point> button. The resulting log entry is created:

<USER66 name=‘BK_PlayResult’>Free Throw Shot</USER66>
<USER19 name=‘Highlight Flag’>**</USER19>
<USER67 name=‘BK_HomeTeamScore’>35</USER67>

At T=14:19:40:00, the user presses the <DUNK 2-points> button. The resulting log entry is created:

<USER66 name=‘BK_PlayResult’>2-Point Dunk</USER66>
<USER19 name=‘Highlight Flag’>****</USER19>
<USER67 name=‘BK_HomeTeamScore’>36</USER67>

At T=14:19:40:00, the user presses the <Missed Shot> button. The resulting log entry is created:

<USER66 name=‘BK_PlayResult’>Missed Shot</USER66>
<USER19 name=‘Highlight Flag’></USER19>
<USER67 name=‘BK_HomeTeamScore’>34</USER67>

At T=14:19:40:00, the user presses the <Foul> button. The resulting log entry is created:

<USER66 name=‘BK_PlayResult’>Foul</USER66>
<USER19 name=‘Highlight Flag’></USER19>
<USER67 name=‘BK_HomeTeamScore’>34</USER67>

At T=14:19:40:00, the user presses the <Blocked Shot> button. The resulting log entry is created:

<USER66 name=‘BK_PlayResult’>Blocked Shot</USER66>
<USER19 name=‘Highlight Flag’>***</USER19>
<USER67 name=‘BK_HomeTeamScore’>34</USER67>

At T=14:19:40:00, the user presses the <Steal> button. The resulting log entry is created:

<USER66 name=‘BK_PlayResult’>Steal</USER66>
<USER19 name=‘Highlight Flag’>***</USER19>
<USER67 name=‘BK_HomeTeamScore’>34</USER67>

At T=14:19:40:00, the user presses the <Mark Play> button. The resulting log entry is created:

<USER66 name=‘BK_PlayResult’></USER66>
<USER19 name=‘Highlight Flag’>*****</USER19>
<USER67 name=‘BK_HomeTeamScore’>34</USER67>

In another implementation, related to Appendix C, log events can be created as follows.

At T=14:19:40:00, the user presses the <2-points> button. He is then prompted to select the player that scored. He selects #5 from the home team roster (This player's name is Tim Smith, member #245 (MID)). The resulting XML data generated for this logged entry is:

```
<eventTag>
    <in>14:19:30:00</in>
    <out>14:19:45:00</out>
    <highlight>false</highlight>
    <metadata>
        <value key=“BK_PlayersInvolved”>Tim Smith</value>
        <value key=“BK_IDPlayersInvolved”>245</value>
        <value key=“BK_HomeTeamID”>20</value>
        <value key=“BK_AwayTeamID”>65</value>
        <value key=“BK_Quarter”>1</value>
        <value key=“BK_PlayResult”>2 Point Shot</value>
        <value key=“BK_Possession”>Home</value>
        <value key=“BK_HomeTeamScore”>36</value>
        <value key=“BK_AwayTeamScore”>28</value>
    </metadata>
</eventTag>
```

In this example, various data comes from the following fields in the assignment file. The HomeTeamID comes from the first <Club ID> entry. The AwayTeamID comes from the second <Club ID> entry. Additionally the IDPlayersInvolved and PlayersInvolved are automatically populated by cross referencing the player's jersey # <Identifier> and corresponding <mid> and <FirstName><LastName> information contained in the assignment file.

At T=14:20:10:00, the user presses the <3-points> button. He is then prompted to select the player that scored. He selects #10 from the home team roster (This player's name is Phil Shapiro, member #268 <MID>). The resulting XML data generated for this logged entry is:

```
<eventTag>
    <in>14:20:00:00</in>
    <out>14:20:15:00</out>
    <highlight>true</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>3 Point Shot</value>
        <value key=“BK_Possession”>Home</value>
        <value key=“BK_HomeTeamScore”>39</value>
        <value key=“BK_AwayTeamScore”>28</value>
    </metadata>
```

</eventTag>

At T=14:19:40:00, the user presses the <1-point> button. He is then prompted to select the player that scored. He selects #10 from the home team roster (This player's name is Phil Shapiro, member #268 <MID>). The resulting XML data generated for this logged entry is:

```
<eventTag>
    <in>14:19:30:00</in>
    <out>14:19:45:00</out>
    <highlight>false</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>1 Point Shot</value>
        <value key=“BK_Possession”>Home</value>
        <value key=“BK_HomeTeamScore”>40</value>
        <value key=“BK_AwayTeamScore”>28</value>
    </metadata>
</eventTag>
```

At T=14:19:40:00, the user presses the <DUNK 2-points> button. He is then prompted to select the player that scored. He selects #10 from the home team roster (This player's name is Phil Shapiro, member #268 <MID>). The resulting XML data generated for this logged entry is:

```
<eventTag>
    <in>14:19:30:00</in>
    <out>14:19:45:00</out>
    <highlight>true</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>Dunk</value>
        <value key=“BK_Possession”>Home</value>
        <value key=“BK_HomeTeamScore”>42f</value>
        <value key=“BK_AwayTeamScore”>28</value>
    </metadata>
</eventTag>
```

At T=14:19:40:00, the user presses the <Missed Shot> button. He is then prompted to select the player that scored. He selects #10 from the home team roster (This player's name is Phil Shapiro, member #268 <MID>). The resulting XML data generated for this logged entry is:

```
<eventTag>
    <in>14:19:30:00</in>
    <out>14:19:45:00</out>
    <highlight>false</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>Missed Shot</value>
        <value key=“BK_Possession”>Home</value>
        <value key=“BK_HomeTeamScore”>42</value>
        <value key=“BK_AwayTeamScore”>28</value>
    </metadata>
</eventTag>
```

At T=14:19:40:00, the user presses the <Foul> button. He is then prompted to select the player that scored. He selects #10 from the home team roster (This player's name is Phil Shapiro, member #268 <MID>). The resulting XML data generated for this logged entry is:

```
<eventTag>
    <in>14:19:30:00</in>
    <out>14:19:45:00</out>
    <highlight>false</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>Foul</value>
        <value key=“BK_Possession”>Home</value>
        <value key=“BK_HomeTeamScore”>42</value>
        <value key=“BK_AwayTeamScore”>28</value>
    </metadata>
</eventTag>
```

At T=14:19:40:00, the user presses the <Blocked Shot> button. He is then prompted to select the player that scored. He selects #10 from the home team roster (This player's name is Phil Shapiro, member #268 <MID>). The resulting XML data generated for this logged entry is:

```
<eventTag>
    <in>14:19:30:00</in>
    <out>14:19:45:00</out>
    <highlight>false</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>Blocked Shot</value>
        <value key=“BK_Possession”>Home</value>
        <value key=“BK_HomeTeamScore”>42</value>
        <value key=“BK_AwayTeamScore”>28</value>
    </metadata>
</eventTag>
```

At T=14:19:40:00, the user presses the <Steal> button. He is then prompted to select the player that scored. He selects #10 from the home team roster (This player's name is Phil Shapiro, member #268 <MID>). The resulting XML data generated for this logged entry is:

```
<eventTag>
    <in>14:19:30:00</in>
    <out>14:19:45:00</out>
    <highlight>false</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>Steal</value>
        <value key=“BK_Possession”>Home</value>
        <value key=“BK_HomeTeamScore”>42</value>
        <value key=“BK_AwayTeamScore”>28</value>
    </metadata>
</eventTag>
```

At T=14:19:40:00, the user presses the <Mark Play> button. He is then prompted to select the player that scored. He selects #10 from the home team roster (This player's name is Phil Shapiro, member #268 <MID>). The resulting XML data generated for this logged entry is:

```
<eventTag>
    <in>14:19:30:00</in>
    <out>14:19:45:00</out>
    <highlight>true</highlight>
    <metadata>
        <value key=“BK_PlayersInvolved”>Phil Shapiro</value>
        <value key=“BK_IDPlayersInvolved”>268</value>
        <value key=“BK_HomeTeamID”>20</value>
        <value key=“BK_AwayTeamID”>65</value>
        <value key=“BK_Quarter”>1</value>
        <value key=“BK_PlayResult”>Marked Play</value>
        <value key=“BK_Possession”>Home</value>
        <value key=“BK_HomeTeamScore”>42</value>
        <value key=“BK_AwayTeamScore”>28</value>
    </metadata>
</eventTag>
```

The left (HOME) side 530 and right (AWAY) side 532 of the interface are used to display the lists of players in each team that are present at the game. In this example, each player has a button with a jersey number, and the buttons are displayed in numerical order with the lowest values at the top. The background colors for these areas are the ones selected previously for the home and away teams through the color selector. This section can be similar for other sports.

A separate interface can be provided to allow a user to select which players are present from the complete roster. The buttons can also be color coded to indicate whether the player is on the court or off the court. For example, each button can be either colored with a blue background when the player is identified as being ON-THE-FIELD, or with a red background when the player is identified as OFF-THE-FIELD. The user can toggle the ON-THE-FIELD/OFF-THE-FIELD status of each player by simply pressing the player's corresponding button. Because, in basketball, the number of players on the field is limited to 5 per team, the logging tool can limit 5 players to be selected as ON-THE-FIELD at any given time. A similar interface can be provided for other sports.

Another user interface can be provided to allow the list of players to be edited, including whether they are present at the game, the jersey number, role on the team, etc. This list can be used by the logging tool to prompt for input during the game. It also can be exported as part of the log file.

For basketball in FIG. 5, a scoreboard 540 is in the central area of the main logging screen. It is composed of a time display, the home and away teams scores and an indicator for the current period. The time display 542 shows the time of day. It can be retrieved from the clock value of the host computer. The quarter display 544 is a user setting. The user can modify the quarter value by pressing on the label 544, for example. Changing the quarter sets the BK_Quarter field which is stored in each log entry. The home and away scores are shown at 546 and 548 respectively. These scores display the BK_HomeTeamScore and BK_AwayTeamScore values that are updated as players score and the events for those scores are logged. In addition, if for some reason there is an error in the displayed score, the user can modify the score by pressing on the label for example, which can in turn prompt the user to enter a correct score.

The user interface also includes a save/export button 550. In response to a user pressing this button, the log entries for the activity, or for a segment of the activity if the activity is not yet completed, are processed. For example, if the log entries are stored in memory, they can be saved to a file. However, preferably, a file is being used to store the log entries, and this file is continually updated on the fly after each event to prevent loss of logged information. Pressing the SAVE/EXPORT can close the file. After closing the file the system can perform a variety of other actions. For example, an email window can be opened with the file as an attachment. Another file can be opened for the next segment of the activity.

It should also be pointed out that the data used to log events also can be used to name events and their related video clips. An example naming convention for events in the logged data for basketball, as found in Appendix B, is the following: 3-Point/2-Point/1-Point/Dunk 2-Point/Blocked Shot/Foul/Steal. These values can be used to make up the names of the events and hence the sub clips. For example, a log event may include the following data:

<AssignmentID>
<MID>
<BK_PlayResult>
Part_<BK_Period>
<UniqueCounter>
<HighlightFlag>

From these field names, the name of an event/sub clip can be in the form of: <AssignmentID>_<MID>_<BK_PlayResult/PlayType>_<HighlightFlag>_Part<BK_Period> _<UniqueCounter>. Thus, as a concrete example, the name of an event/sub clip can be: 123_{—}359_{—}3-PointShot_{—}4-Star_Part2_{—}1.

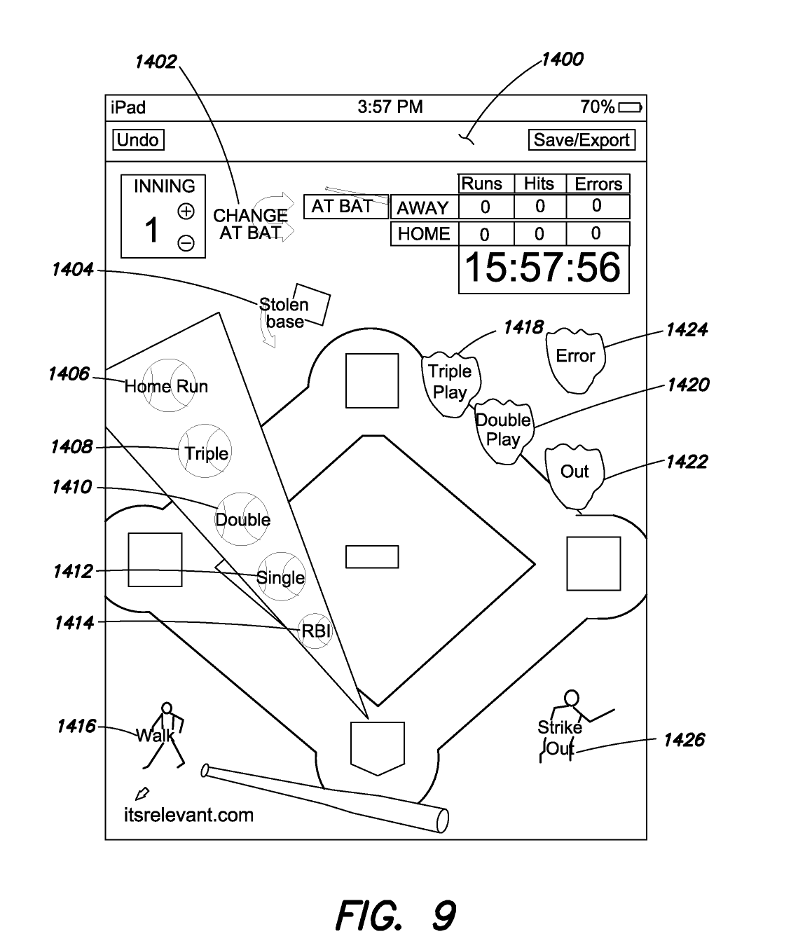

Interfaces for other sports will now be described in connection with FIGS. 9-13.

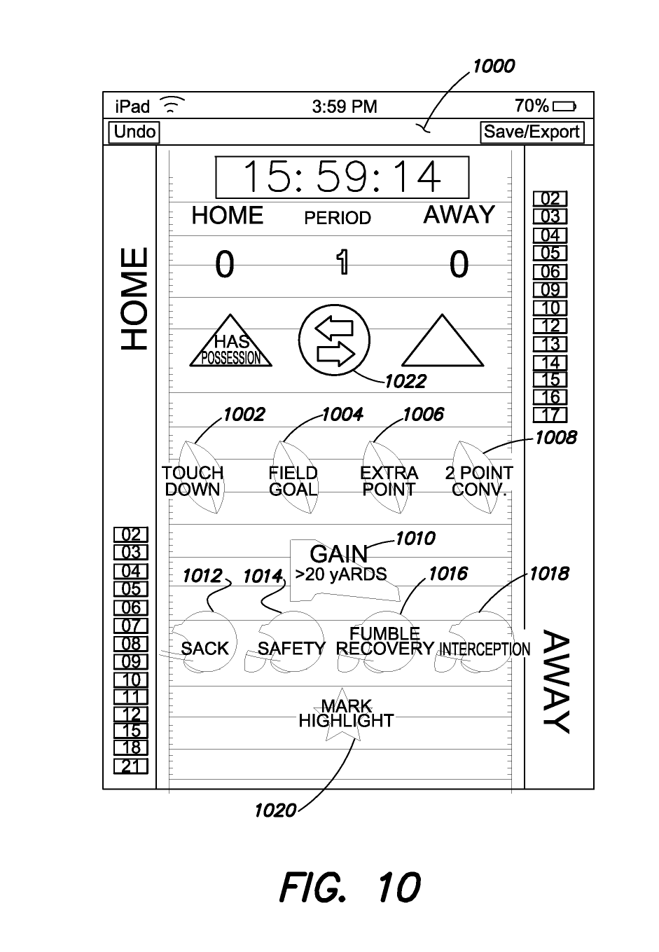

Referring now to FIG. 10, an example user interface for a logging tool will now be described. This user interface has been designed for logging a football game.

Prior to displaying this interface, the logging tool can display a color selector to allow the journalist to select a color for each of the teams. The selected colors are used in the logging interface as background color for buttons assigned to the teams.

The user interface of FIG. 10 is a main page from which logging is performed. For most actions, the user presses only two buttons without requiring confirmation. Escaping from an event button generally is accessible by pressing anywhere outside a dialog screen according to usual user interface convention.

Within the user interface, a title bar 1000 displays the name of the selected assignment file. The title bar also can display navigation buttons in order to provide the user with access to the ability to select a different assignment file, change color selections, or view, save or export the log file and participant information.

A center button 1022 makes the possession status toggle between the HOME team (on the left) and the AWAY team (on the right). Each time this button is pressed, a “BK_Possession” variable is set to the selected team (BK_Possession=HomeTeam or AwayTeam).

The main logging buttons will now be described in connection with Table II, which describes the actions tied to each button available. The table indicates the metadata keys values (BK_PlayResult, and HighlightFlag) associated with the press of each button. The Notes indicate other actions that are performed by the logging tool, such as updating the score, or prompting the journalist for information about the player. Each time one of the buttons is pressed, the user is prompted to identify the player(s) that was (were) involved in the logged event. A user interface with buttons corresponding to each of the players can be displayed for this purpose. With such an interface, the user can either select a player from the HOME or AWAY team, or, in the event he does not know which player was involved, he can select the HOME or AWAY team button.

TABLE II

| Button | BK_PlayResult | HighlightFlag | NOTES |
|---|---|---|---|
| Touchdown -- 1002 | Touchdown | TRUE | If (Possession = “HOME”) |
| | | | HomeTeamScore = HomeTeamScore + 6. |
| | | | If (Possession = “AWAY”) |
| | | | AWAYTeamScore = AWAYTeamScore + 6 |
| Field Goal -- 1004 | Field Goal | TRUE | If (Possession = “HOME”) |
| | | | HomeTeamScore = HomeTeamScore + 3. |
| | | | If (Possession = “AWAY”) |
| | | | AWAYTeamScore = AWAYTeamScore + 3 |
| Extra Point -- 1006 | Extra Point | FALSE | If (Possession = “HOME”) |
| | | | HomeTeamScore = HomeTeamScore + 1. |
| | | | If (Possession = “AWAY”) |
| | | | AWAYTeamScore = AWAYTeamScore + 1 |
| 2 Point Conv. -- 1008 | 2 Point Conversion | FALSE | If (Possession = “HOME”) |
| | | | HomeTeamScore = HomeTeamScore + 2. |
| | | | If (Possession = “AWAY”) |
| | | | AWAYTeamScore = AWAYTeamScore + 2 |
| Gain >20 Yards -- 1010 | Huge Gain | TRUE | |
| Sack -- 1012 | Sack | FALSE | |
| Safety -- 1014 | Safety | TRUE | If (Possession = “AWAY”) |
| | | | HomeTeamScore = HomeTeamScore + 2. |
| | | | If (Possession = “Home”) |
| | | | AWAYTeamScore = AWAYTeamScore + 2 |
| Fumble Recovery -- 1016 | Fumble Recovery | FALSE | |
| Interception -- 1018 | Interception | FALSE | |
| Mark Highlight -- 1020 | Marked Play | TRUE | |

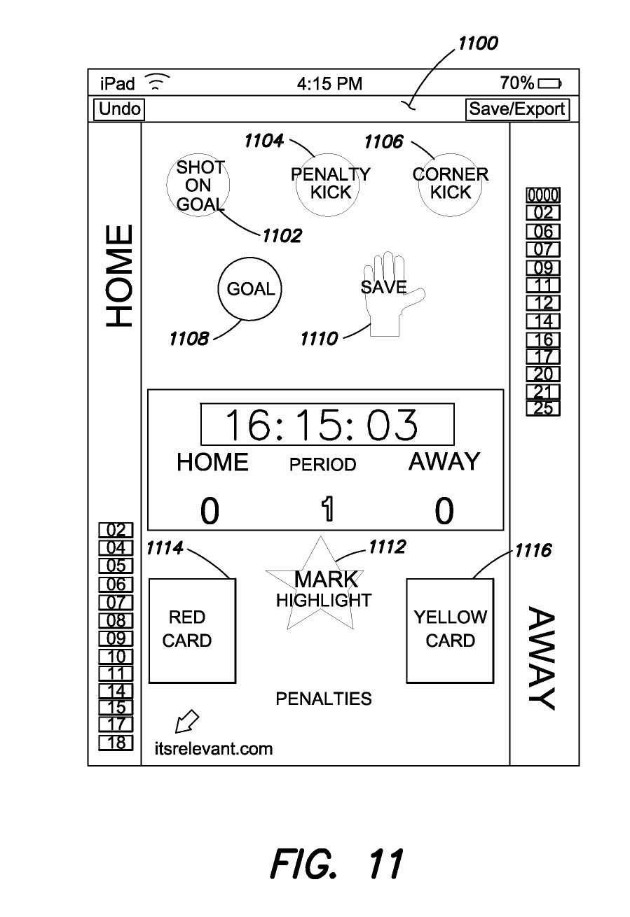

Referring now to FIG. 11, an example user interface for a logging tool will now be described. This user interface has been designed for logging a soccer game.

Prior to displaying this interface, the logging tool can display a color selector to allow the journalist to select a color for each of the teams. The selected colors are used in the logging interface as background color for buttons assigned to the teams.

The user interface of FIG. 11 is a main page from which logging is performed. For most actions, the user presses only two buttons without requiring confirmation. Escaping from an event button generally is accessible by pressing anywhere outside a dialog screen according to usual user interface convention.

Within the user interface, a title bar 1100 displays the name of the selected assignment file. The title bar also can display navigation buttons in order to provide the user with access to the ability to select a different assignment file, change color selections, or view, save or export the log file and participant information.

The main logging buttons will now be described in connection with Table III, which describes the actions tied to each button available. The table indicates the metadata keys values (BK_PlayResult, and HighlightFlag) associated with the press of each button. The Notes indicate other actions that are performed by the logging tool, such as updating the score, or prompting the journalist for information about the player. Each time one of the buttons is pressed, the user is prompted to identify the player(s) that was (were) involved in the logged event. A user interface with buttons corresponding to each of the players can be displayed for this purpose. With such an interface, the user can either select a player from the HOME or AWAY team, or, in the event he does not know which player was involved, he can select the HOME or AWAY team button.

TABLE III

| Button | BK_PlayResult | HighlightFlag | NOTES |
|---|---|---|---|
| Shot on Goal -- 1102 | Shot on Goal | FALSE | |
| Penalty Kick -- 1104 | Penalty Kick | FALSE | |
| Corner Kick -- 1106 | Corner Kick | FALSE | |
| Goal -- 1108 | Goal | TRUE | If the user selects a player on the HOME |
| | | | team then |
| | | | HomeTeamScore = HomeTeamScore + 1. If |
| | | | the user selects a player on the AWAY team |
| | | | then AwayTeamScore = AwayTeamScore + 1. |
| Save -- 1110 | Save | TRUE | |
| Mark Highlight -- 1112 | Mark Highlight | TRUE | |
| Red Card -- 1114 | Red Card | FALSE | |
| Yellow Card -- 1116 | Yellow Card | FALSE | |

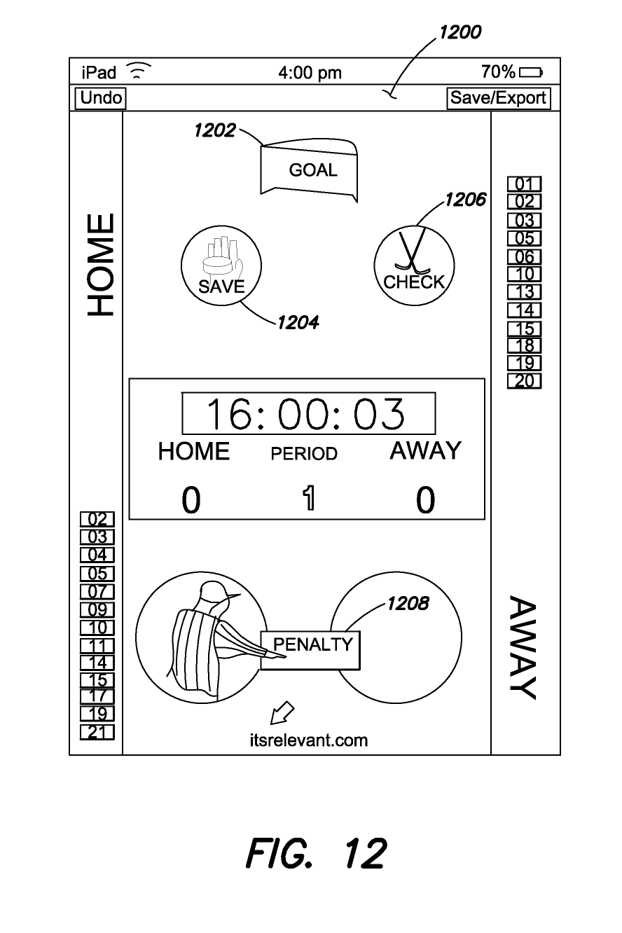

Referring now to FIG. 12, an example user interface for a logging tool will now be described. This user interface has been designed for logging a hockey game.

Prior to displaying this interface, the logging tool can display a color selector to allow the journalist to select a color for each of the teams. The selected colors are used in the logging interface as background color for buttons assigned to the teams.

The user interface of FIG. 12 is a main page from which logging is performed. For most actions, the user presses only two buttons without requiring confirmation. Escaping from an event button generally is accessible by pressing anywhere outside a dialog screen according to usual user interface convention.

Within the user interface, a title bar 1200 displays the name of the selected assignment file. The title bar also can display navigation buttons in order to provide the user with access to the ability to select a different assignment file, change color selections, or view, save or export the log file and participant information.

The main logging buttons will now be described in connection with Table IV, which describes the actions tied to each button available. The table indicates the metadata keys values (BK_PlayResult, and HighlightFlag) associated with the press of each button. The Notes indicate other actions that are performed by the logging tool, such as updating the score, or prompting the journalist for information about the player. Each time one of the buttons is pressed, the user is prompted to identify the player(s) that was (were) involved in the logged event. A user interface with buttons corresponding to each of the players can be displayed for this purpose. With such an interface, the user can either select a player from the HOME or AWAY team, or, in the event he does not know which player was involved, he can select the HOME or AWAY team button.

TABLE IV

| Button | BK_PlayResult | HighlightFlag | NOTES |
|---|---|---|---|
| Goal -- 1202 | Goal | TRUE | If the user selects a player on the HOME team |
| | | | then HomeTeamScore = HomeTeamScore + 1. If |
| | | | the user selects a player on the AWAY team then |
| | | | AwayTeamScore = AwayTeamScore + 1. |
| Save - 1204 | Save | TRUE | |
| Check -- 1206 | Check | FALSE | |
| Penalty -- 1208 | Penalty | FALSE | |

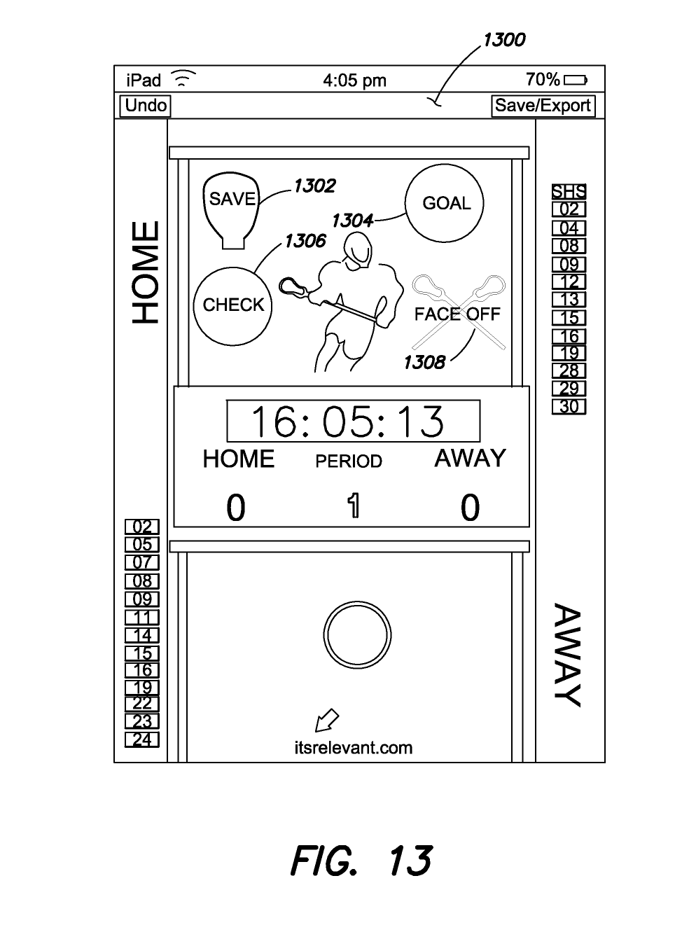

Referring now to FIG. 13, an example user interface for a logging tool will now be described. This user interface has been designed for logging a lacrosse game.

Prior to displaying this interface, the logging tool can display a color selector to allow the journalist to select a color for each of the teams. The selected colors are used in the logging interface as background color for buttons assigned to the teams.

The user interface of FIG. 13 is a main page from which logging is performed. For most actions, the user presses only two buttons without requiring confirmation. Escaping from an event button generally is accessible by pressing anywhere outside a dialog screen according to usual user interface convention.

Within the user interface, a title bar 1300 displays the name of the selected assignment file. The title bar also can display navigation buttons in order to provide the user with access to the ability to select a different assignment file, change color selections, or view, save or export the log file and participant information.

The main logging buttons will now be described in connection with Table V, which describes the actions tied to each button available. The table indicates the metadata keys values (BK_PlayResult, and HighlightFlag) associated with the press of each button. The Notes indicate other actions that are performed by the logging tool, such as updating the score, or prompting the journalist for information about the player. Each time one of the buttons is pressed, the user is prompted to identify the player(s) that was (were) involved in the logged event. A user interface with buttons corresponding to each of the players can be displayed for this purpose. With such an interface, the user can either select a player from the HOME or AWAY team, or, in the event he does not know which player was involved, he can select the HOME or AWAY team button.

TABLE V

| Button | BK_PlayResult | HighlightFlag | NOTES |
|---|---|---|---|
| Save - 1302 | Save | TRUE | |
| Goal - 1304 | Goal | TRUE | If the user selects a player on the HOME |
| | | | team then |
| | | | HomeTeamScore = HomeTeamScore + 1. If |
| | | | the user selects a player on the AWAY team |
| | | | then AwayTeamScore = AwayTeamScore + 1. |
| Check - 1306 | Check | FALSE | |
| Face Off - 1308 | Face Off | FALSE | |

Referring now to FIG. 9, an example user interface for a logging tool will now be described. This user interface has been designed for logging a baseball or softball game.

Prior to displaying this interface, the logging tool can display a color selector to allow the journalist to select a color for each of the teams. The selected colors are used in the logging interface as background color for buttons assigned to the teams.

The user interface of FIG. 9 is a main page from which logging is performed. For most actions, the user presses only two buttons without requiring confirmation. Escaping from an event button generally is accessible by pressing anywhere outside a dialog screen according to usual user interface convention.

Within the user interface, a title bar 1400 displays the name of the selected assignment file. The title bar also can display navigation buttons in order to provide the user with access to the ability to select a different assignment file, change color selections, or view, save or export the log file and participant information.

A Change At Bat button 1402 makes the possession status toggle between the HOME team and the AWAY team. Each time this button is pressed, a “BK_Possession” variable is set to the selected team (BK_Possession=HomeTeam or AwayTeam).

The main logging buttons will now be described in connection with Table VI, which describes the actions tied to each button available. The table indicates the metadata keys values (BK_PlayResult, and HighlightFlag) associated with the press of each button. The Notes indicate other actions that are performed by the logging tool, such as updating the score, or prompting the journalist for information about the player. Each time one of the buttons is pressed, the user is prompted to identify the player(s) that was (were) involved in the logged event. A user interface with buttons corresponding to each of the players can be displayed for this purpose. With such an interface, the user can either select a player from the HOME or AWAY team, or, in the event he does not know which player was involved, he can select the HOME or AWAY team button.

TABLE VI

| Button | BK_PlayResult | HighlightFlag | SCORE NOTES | HITS NOTES |
|---|---|---|---|---|
| Change | | | If (Possession = “HOME”) change to | |
| At Bat -- | | | (Possession = “AWAY”). If | |
| 1402 | | | (Possession = “AWAY”) change to | |
| | | | (Possession = “HOME”) - this is a | |
| | | | system state change, does not actively | |
| | | | write meta-data | |
| Stolen | Stolen Base | FALSE | | |
| Base -- | | | | |
| 1404 | | | | |
| Home | Home Run | TRUE | If (Possession = “Away”) change | If (Possession = |
| Run -- | | | HomeTeamScore according to user | “Away”) then |
| 1406 | | | input as follows: 0 Runs | HomeTeamHits = |
| | | | Scored = AwayTeamScore + 0, 1 Run | HomeTeamHits + 1. |
| | | | Scored = AwayTeamScore + 1, 2 Runs | If (Possession = |
| | | | Scored = AwayTeam + 2, etc. If | “Home”) then |
| | | | (Possession = “HOME”) change | AwayTeamHits = |
| | | | AwayTeamScore according to user | AwayTeamHits + 1 |
| | | | input as follows: 0 Runs | |
| | | | Scored = HomeTeamScore + 0, 1 Run | |
| | | | Scored = HomeTeamScore + 1, 2 Runs | |
| | | | Scored = HomeTeamScore + 2, etc. | |
| Triple -- | Triple | TRUE | If (Possession = “Away”) change | If (Possession = |
| 1408 | | | HomeTeamScore according to user | “Away”) then |
| | | | input as follows: 0 Runs | HomeTeamHits = |
| | | | Scored = AwayTeamScore + 0, 1 Run | HomeTeamHits + 1. |
| | | | Scored = AwayTeamScore + 1, 2 Runs | If (Possession = |
| | | | Scored = AwayTeam + 2, etc. If | “Home”) then |
| | | | (Possession = “HOME”) change | AwayTeamHits = |
| | | | AwayTeamScore according to user | AwayTeamHits + 1 |
| | | | input as follows: 0 Runs | |
| | | | Scored = HomeTeamScore + 0, 1 Run | |
| | | | Scored = HomeTeamScore + 1, 2 Runs | |
| | | | Scored = HomeTeamScore + 2, etc. | |
| Double -- | Double | FALSE | If (Possession = “Away”) change | If (Possession = |
| 1410 | | | HomeTeamScore according to user | “Away”) then |
| | | | input as follows: 0 Runs | HomeTeamHits = |
| | | | Scored = AwayTeamScore + 0, 1 Run | HomeTeamHits + 1. |
| | | | Scored = AwayTeamScore + 1, 2 Runs | If (Possession = |
| | | | Scored = AwayTeam + 2, etc. If | “Home”) then |
| | | | (Possession = “HOME”) change | AwayTeamHits = |
| | | | AwayTeamScore according to user | AwayTeamHits + 1 |
| | | | input as follows: 0 Runs | |
| | | | Scored = HomeTeamScore + 0, 1 Run | |
| | | | Scored = HomeTeamScore + 1, 2 Runs | |
| | | | Scored = HomeTeamScore + 2, etc. | |
| Single -- | Single | FALSE | If (Possession = “Away”) change | If (Possession = |
| 1412 | | | HomeTeamScore according to user | “Away”) then |
| | | | input as follows: 0 Runs | HomeTeamHits = |
| | | | Scored = AwayTeamScore + 0, 1 Run | HomeTeamHits + 1. |
| | | | Scored = AwayTeamScore + 1, 2 Runs | If (Possession = |
| | | | Scored = AwayTeam + 2, etc. If | “Home”) then |
| | | | (Possession = “HOME”) change | AwayTeamHits = |
| | | | AwayTeamScore according to user | AwayTeamHits + 1 |
| | | | input as follows: 0 Runs | |
| | | | Scored = HomeTeamScore + 0, 1 Run | |
| | | | Scored = HomeTeamScore + 1, 2 Runs | |
| | | | Scored = HomeTeamScore + 2, etc. | |
| RBI -- | RBI | FALSE | If (Possession = “Away”) change | |
| 1414 | | | HomeTeamScore according to user | |
| | | | input as follows: 0 Runs | |
| | | | Scored = AwayTeamScore + 0, 1 Run | |
| | | | Scored = AwayTeamScore + 1, 2 Runs | |
| | | | Scored = AwayTeam + 2, etc. If | |
| | | | (Possession = “HOME”) change | |
| | | | AwayTeamScore according to user | |
| | | | input as follows: 0 Runs | |
| | | | Scored = HomeTeamScore + 0, 1 Run | |
| | | | Scored = HomeTeamScore + 1, 2 Runs | |
| | | | Scored = HomeTeamScore + 2, etc. | |
| Walk -- | Walk | FALSE | If (Possession = “Away”) change | |
| 1416 | | | HomeTeamScore according to user | |
| | | | input as follows: 0 Runs | |
| | | | Scored = AwayTeamScore + 0, 1 Run | |
| | | | Scored = AwayTeamScore + 1, 2 Runs | |
| | | | Scored = AwayTeam + 2, etc. If | |
| | | | (Possession = “HOME”) change | |
| | | | AwayTeamScore according to user | |
| | | | input as follows: 0 Runs | |
| | | | Scored = HomeTeamScore + 0, 1 Run | |
| | | | Scored = HomeTeamScore + 1, 2 Runs | |
| | | | Scored = HomeTeamScore + 2, etc. | |
| Triple | Triple Play | TRUE | | |
| Play -- | | | | |
| 1418 | | | | |
| Double | Double Play | TRUE | | |
| Play -- | | | | |
| 1420 | | | | |
| Out -- | Out | FALSE | | |
| 1422 | | | | |
| Error -- | Error | FALSE | | |
| 1424 | | | | |
| Strike | Strike Out | FALSE | | |
| Out -- | | | | |
| 1426 | | | | |

Having now described an example implementation of a logging tool, an example editing tool will now be described in connection with FIG. 6.

The editing tool takes the log files created by the logging tool, imports video from the camera, processes the data in the log file with video clips for the activity, clips the video accordingly, allows the editor to edit the clips and the sequence of clips, and then exports the video program to a distribution channel. In this example implementation, this tool unifies several steps of the sports production workflow described above.

The editing tool can have several different interfaces, or screens, through which an editor can access different operations in this work flow. For example, one screen can be provided for a user to select a project to work on, based on the log files that are present in a defined folder. Projects can be labeled as unfinished projects and finished projects, and can be listed with the most recent projects at the top. “Finished” projects are those that the editing tool has already processed through to an upload of a final edited video. Given a selected project, video data can be imported into the editing application and the log file for the assignment can be opened by the editing application. After video is imported, time code synchronization with the log files can be check, and resynchronization can be performed, in a manner described below.

The editing tool also can have a screen, called a clip list screen, which allows the user to make selections from the clips that were created in the log file. An example is shown in FIG. 7. Clips that are marked as highlights can be displayed at the top 702 of a list view 700. Other clips are shown at the bottom 706 of the list view. A search and/or filter function can be accessed through an input field 704 to allow a user to search clips, filter those viewed, etc., by any of the valid fields in the log file. The clips marked as highlights from the original clip list define the edited video. Through conventional user interface techniques, the user can be enabled to manipulate this list by selecting clips, adding a selected clip to the highlights, and/or removing a selected clip from the highlights. Also, the user can select any clip from this view to open in a detailed View/Edit Clip screen shown in FIG. 6, for example by pressing butt “play/edit clip” 705.

Another button 724 can be provided, called an Edit Abstract button, to allow the user to type an abstract that will be included in the output of the editing tool, and can be displayed at 726. Such data can be passed through on playback to a graphics overly generator, for example. A “Play All Highlights” button 728 can be provided, which when pressed by the user causes the tool to present video playback of all the selected clips, optionally with overlay graphics. Another button can be provided, that when selected causes the tool to compute and display the total run time (displayed at 730) of the selected clips. An export button can be provided to allow a user to send the completed edit program description.

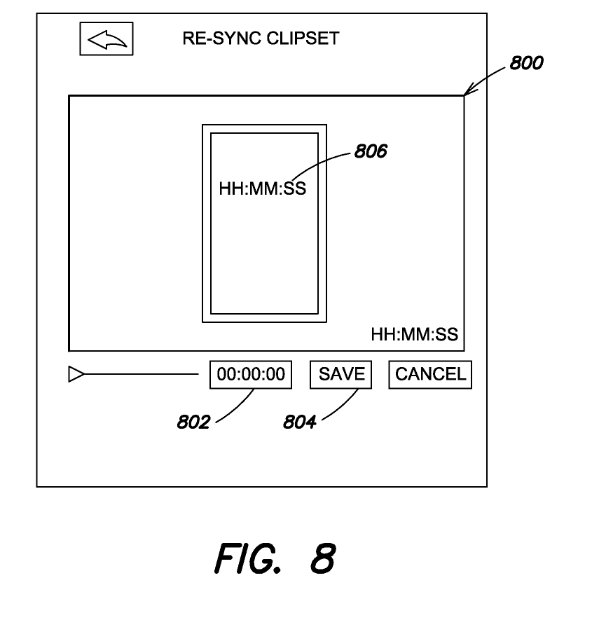

Another button 732 can be provided that causes a synchronization screen to be displayed, an example of which is shown in FIG. 8. In one implementation, the editing tool plays back the first original source video file for the activity, or video of a known event in the activity, and prompts the user to mark the point at which the first logged event, or other known event, takes place. This screen can display the play result and player involved for the event so that the user can visually confirm that they are marking the correct event. Alternatively, as shown in FIG. 8, the user can play back video where the clock from the device is visible (at 806) and the clock is moving, as shown in a video window 800. The video can be paused. In a box 802, the time from the device's clock in the video can be entered. This time can then be saved by pressing button 804. The editing tool sets a time code offset (based on the information on the first event or the entered time from the video of the device clock) to account for the difference between the time code entries for events in the log file and the video time code.

The editing tool can have another screen that can be accessed by selecting a Save/Export/Upload button, which can be placed on the clip list screen or editing screen. This screen displays the upload progress and provides the user with data about connection speed, time elapsed and estimated time remaining Upon completion of the highlights upload this screen can be used to prompt the user to upload full quarter files to a different server location for coaches to download and view later.

The screen shown in FIG. 6 allows a user to playback an edit a clip for a selected event. The clip is played back in a viewer 600, with play control 601, and can include a graphics overlay 602 generated from the log data. During playback the user can define new in-point and out-point for the clip through controls 604 and 606. With the Preview: PLAY IN TO OUT button 608 the user can playback only the selected clip length to preview the finished product. The user can modify the clip's meta data through constrained drop-down lists for play result 610, player involved 612, quarter 614, home score 616 and away score 618. The user can view the Total Run Time 620 for the highlights as presently defined, and can view the Run Time 622 for the individual clip being viewed. The user can skip ahead to the next clip with button 624, skip back to the previous clip with button 626, and return to the Clip set (list) view with button 628 at any time.

Given such an editing tool, an editor typically uses such a system in the following way, after logging of an activity has occurred. The editor imports the video into the editing application by inserting the removable storage from the camera into the device. On some devices, this action automatically causes the device to prompt the user what to do with the files on the storage. The editor opens the editing application, selects an assignment, and instructs the device to begin importing the video files.

The editor then uses the editing application to check and adjust the synchronization between the log file for the assignment and the video files. The editor can then begin editing by reviewing and editing clips, marking and unmarking clips as highlights, and reviewing highlights. Meta data for the clips and an abstract for the video program can also be edited.

When the editor has completed editing, the final video program can be reviewed. For most sports, a highlight video program typically is only a few minutes long, such as 30 seconds to 4 minutes, or one and a half minutes to 3 minutes, depending on the distribution channel. The total run time of the highlights can be checked for this purpose and the program can be made shorter or longer by the editor. When the program has been verified, then the editor can export the project to a format for distribution.

Having now described examples of editing and logging it should be apparent that the foregoing are merely example limitations and that a variety of different kinds of interfaces can be used to enable logging of events and editing of clips based on those logged events.

The techniques described above can be implemented in digital electronic circuitry, or in computer hardware, firmware, software executing on a computer, or in combinations of them. The techniques can be implemented as a computer program product, i.e., a computer program tangibly embodied in tangible, machine-readable storage medium, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. As described above, the logging tool and the editing tool are provided on the same device, such as a tablet computer with a touch screen user interface so as to allow logging, editing and output of a video program to be completed using the one device when provided video data from a camera.

Method steps of the techniques described herein can be performed by one or more programmable processors executing a computer program to perform functions described herein by operating on input data and generating output. Method steps can also be performed by, and apparatus of the invention can be implemented as, special purpose logic circuitry, e.g., an FPGA (field programmable gate array) or an ASIC (application-specific integrated circuit). Applications can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Storage media suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A computing system can include clients and servers. A client and server are generally remote from each other and typically interact over a communication network. The relationship of client and server arises by virtue of computer programs running on the respective computers and having a client-server relationship to each other.

Having described an example embodiment, it should be apparent to those skilled in the art that the foregoing is merely illustrative and not limiting, having been presented by way of example only. Numerous modifications and other embodiments are with the scope of ordinary skill in the art and are contemplated as falling with the scope of the invention.

What is claimed is:

1. A video production device, comprising:
an input for receiving video data from a storage device on which video data was recorded of an activity;
a logging tool integrated in the device and comprising:
a touch-based user interface responsive to user input to allow the user to input data about events occurring during the activity, and
in response to user input about events occurring during the activity, a module that stores data in a memory about the events with time stamps; and
an editing tool integrated in the device and comprising:
a user interface allowing a user to select events;
a module that stores information in memory defining clips of the video data corresponding to the selected events; and
an output tool integrated in the device that receives information defining the clips of video and exports a video program comprising the clips of video of the selected events
